(19) United States
(12) Patent Application Publication
(10) Pub. No.: US 2024/0370261 A1
(43) Pub. Date: Nov. 7, 2024

(54) Systems and Methods Providing Pause for Interrupts and Shared Memory Access

(71) Applicant: TEXAS INSTRUMENTS INCORPORATED, Dallas, TX (US)

(72) Inventor: Alexander Tessarolo, Lindfield (AU)

(21) Appl. No.: 18/426,174

(22) Filed: Jan. 29, 2024

Related U.S. Application Data
(60) Provisional application No. 63/463,592, filed on May 3, 2023.

(51) Int. Cl. G06F 9/30

(52) U.S. Cl. CPC G06F 9/3005; G06F 9/3016

(57) ABSTRACT

Various embodiments include processors, methods, and computer program products providing pauses for interrupts and shared memory accesses. A processor may decode a machine code instruction, that machine code instruction including a quantity representing a count. As a result of decoding the instruction, the processor may set the value of the count in a status register. While the count is non-zero, the processor may pause servicing interrupts and/or may block another processor from performing operations on a shared memory resource. The processor may decrement the count with each subsequent decoded instruction. Servicing interrupts may be un-paused and/or access to the shared memory resource may be un-blocked once the count reaches zero.

### CROSS-REFERENCE TO RELATED APPLICATIONS

This application claims the benefit of U.S. Provisional Application No. 63/463,592, filed May 3, 2023, and entitled “ATOMIC OPERATION FOR SELECTED NUMBER OF INSTRUCTIONS,” the contents of which are incorporated by reference in their entirety.

### BACKGROUND

Computer interrupts are a mechanism that enable a computer's central processing unit (CPU) to efficiently handle and prioritize various tasks and events. When a computer is running, it continually monitors external and internal signals, such as hardware devices requesting attention or software-generated signals. When an interrupt occurs, the CPU temporarily suspends its current task, saves its state, and shifts its focus to the interrupt handler, a specific routine designed to address the interrupt's cause. Interrupts can be categorized into two main types: hardware interrupts, generated by external devices like keyboards or network cards, and software interrupts, triggered by specific software instructions. The CPU's ability to manage and respond to these interruptions in real-time allows modern computers to multitask effectively and provide responsive, interactive user experiences.

In one example, a lower priority task may read data from a memory location, operate on the data, and then store the modified data back into the memory location. However, it is possible that an interrupt may occur during the lower priority task before that lower priority task has written the modified data. For instance, the interrupt may write data to that particular memory location, and then after the interrupt handler routine has finished, then processing may return to the lower priority task, which then writes its modified data into the same memory location. Therefore, the task that depends upon the interrupt to write data may find that it accesses the wrong data in a subsequent operation.

A similar occurrence may happen with shared memory locations, even without interrupts. When two or more CPUs write to a shared memory, there may be a possibility that one CPU corrupts data that would be used by the other CPU.

There is a need in the art for efficient ways to protect against data corruption in interrupt contexts and in shared memory contexts.

### SUMMARY

In an example embodiment, a processor includes a decoder, an interrupt controller communicatively coupled with the decoder, and a counter register communicatively coupled with the decoder, wherein the decoder is configured to: receive a first instruction that includes a counter field, wherein the counter field specifies a count during which the interrupt controller is to be paused from servicing interrupts; decode the first instruction, including: setting a first value in the counter register; instructing the interrupt controller to pause servicing interrupts until the first value has been adjusted to a specified limit; and adjust the count with each subsequently decoded instruction.

In another example embodiment, a method includes fetching a first instruction, wherein the first instruction is an instance of a machine code instruction within a machine instruction set of a processor; decoding the first instruction, wherein the first instruction specifies a count during which the interrupt controller is to be paused from servicing interrupts; setting a first value in a counter register, wherein the first value represents the count; instructing an interrupt controller of the processor to pause servicing interrupts until the first value has been adjusted to a specified limit; receiving an interrupt signal at the interrupt controller during a time in which the first value has not been adjusted to the specified limit; and servicing the interrupt only upon determining that the first value has been adjusted to the specified limit.

In yet another example embodiment, a non-transitory computer readable medium storing a computer program comprising sets of computer readable instructions for execution by a computer processor, wherein the computer program is such that, when the sets of computer readable instructions are executed by the processor, the processor is caused to: set a first value in a counter register, wherein the first value represents a count during which the interrupt controller is to be paused from servicing interrupts; instruct an interrupt controller of the processor to pause servicing interrupts until the first value has been adjusted to a limit; receive an interrupt signal at the interrupt controller during a time in which the count is non-zero; decode subsequent instructions and decrementing the count with each subsequent instruction decoded; and service the interrupt only upon determining that the counter register stores the limit.

In another example embodiment, a method includes decoding a first machine code instruction at a first processor, wherein the first machine code instruction specifies a count during which a processor blocks access to a shared memory location; setting a first non-zero value in a counter register to represent the count; instructing the memory to block access to the shared memory location; decoding a second machine code instruction at a second processor during a time in which the count is non-zero; decrementing the count with each subsequent instruction decoded at the first processor; not instructing the memory to block access to the shared location upon determining that the count is zero; and accessing the shared memory location by the second processor according to the second machine code instruction. Further embodiments may include a processor that includes a decoder, an interrupt controller communicatively coupled with the decoder, and a counter register communicatively coupled with the decoder, wherein the decoder is configured to perform such method. Further embodiments may include a non-transitory computer readable medium storing a computer program comprising sets of computer readable instructions for execution by a computer processor, wherein the computer program is such that, when the sets of computer readable instructions are executed by the processor, the processor is caused to perform such method.

In another example embodiment, a method includes decoding a first machine code instruction at a first processor, wherein the first machine code instruction specifies a count during which a processor blocks access to a shared memory location; setting a first value in a counter register to be zero; instructing the memory to block access to the shared memory location; decoding a second machine code instruction at a second processor during a time in which the first value has not been adjusted to a limit specified by the count; incrementing the first value with each subsequent instruction decoded at the first processor; not instructing the memory to block access to the shared location upon determining that the count is at the limit; and accessing the shared memory location by the second processor according to the second machine code instruction. Further embodiments may include a processor that includes a decoder, an interrupt controller communicatively coupled with the decoder, and a counter register communicatively coupled with the decoder, wherein the decoder is configured to perform such method. Further embodiments may include a non-transitory computer readable medium storing a computer program comprising sets of computer readable instructions for execution by a computer processor, wherein the computer program is such that, when the sets of computer readable instructions are executed by the processor, the processor is caused to perform such method.

### BRIEF DESCRIPTION OF THE DRAWINGS

Reference will now be made to the accompanying drawings, wherein:

FIG. 1 is an illustration of an example processor, configured to pause interrupts and shared memory accesses, according to various embodiments.

FIG. 2 is an illustration of an example machine code instructions, which may be fetched and decoded by the processor of FIG. 1, according to various embodiments.

FIG. 3 is an illustration of an example method, which may be performed by the processor of FIG. 1, according to various embodiments.

FIG. 4 is an illustration of an example arrangement of processors and shared memory, according to various embodiments.

FIG. 5 is an illustration of an example method, which may be performed by the processors of FIGS. 1 and 4, according to various embodiments.

FIG. 6 is an illustration of an example method, which may be performed by the processors of FIGS. 1 and 4, according to various embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Various embodiments provide techniques to pause an interrupt or a shared memory access. For instance, the techniques described herein may be used in some implementations to prevent or reduce data corruption.

In one example, a machine code instruction includes a counter field. The counter field specifies a count during which an interrupt controller of a processor is to be paused from servicing interrupts. When executed, the instruction causes the processor to pause servicing interrupts and to set a counter to a value specified in the counter field. With each subsequent instruction that is decoded, the processor decrements the counter. Once the counter reaches zero, interrupt servicing is un-paused.

Such an example is different from enabling and disabling interrupts. Interrupts may be enabled or disabled through the concept of maskable interrupts. This mechanism is used for controlling the flow of interrupt requests and managing their priority. Typically, a special interrupt control register, often referred to as the Interrupt Enable (IE) or Interrupt Disable (ID) register, is used to manage interrupt states. When interrupts are enabled, this register holds a flag that allows the CPU to respond to incoming interrupts. When interrupts are disabled, the flag is cleared, preventing the CPU from responding to any interrupt requests. Thus, interrupt signals received during a period when interrupts are disabled are ignored. However, disabling interrupts may use time and processor resources to save the state of the enable or disable register, and then the same state may be restored when interrupts are re-enabled. For instance, enabling or disabling interrupts may use around ten operating cycles or so to flush the pipeline, store, and restore state.

By contrast, the machine code instruction that causes interrupt servicing to be paused does not ignore interrupt signals. Rather, the machine code instruction causes the interrupt servicing to be delayed but nevertheless performed. Furthermore, the machine code instruction that causes interrupt servicing to be paused does not change the state of a flag in the IE or ID register and, thus, does not use processing resources to flush the pipeline, store, and restore state. In some instances, the machine code instruction may have a cost of one operating cycle to be performed, but that may be less than the number of operating cycles used to enable and disable interrupts.

In another example, a second machine code instruction may be used to prevent access to a shared random-access memory (RAM) location. For instance, when decoded by a first CPU, the machine code instruction may cause the RAM wrapper to block access to the RAM location for other CPUs. The second machine code instruction may also include a counter field, where the counter field specifies a count during which access to the RAM location is to be blocked. As the CPU decodes subsequent instructions, it decrements the counter. Once the counter reaches zero, the CPU allows the RAM wrapper to allow access for other CPUs.

In another example, a third machine code instruction may be used to force the counter associated with the above instructions to zero, thereby causing interrupt servicing to be un-paused and/or RAM access to be un-blocked.

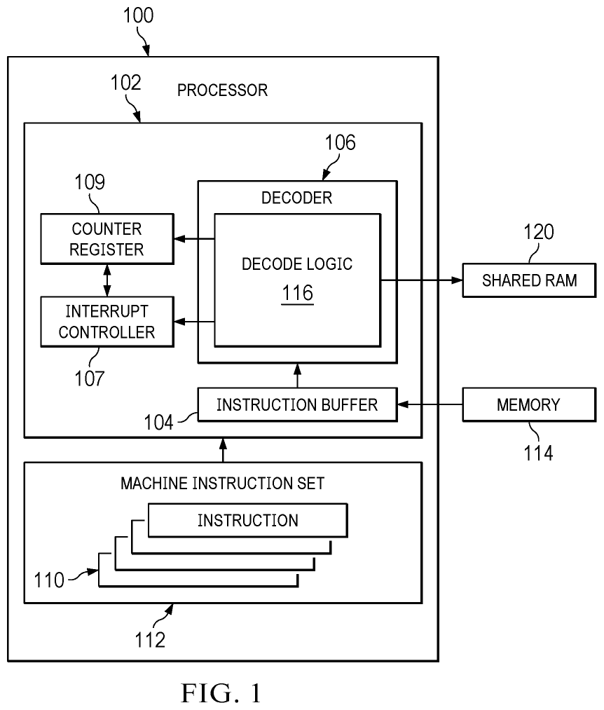

FIG. 1 shows a block diagram of a processor 100 (e.g., a CPU) in accordance with an example. Processor 100 may be included on a semiconductor die in a semiconductor package and may be included on the semiconductor die with other processors (not shown). Furthermore, shared RAM 120 and memory 114 may also be disposed on the same semiconductor die or on a different semiconductor die.

The processor 100 as shown includes a core 102, which contains a prefetch instruction buffer 104, a decoder 106, an interrupt controller 107, and a counter register 109. The core 102 may contain other hardware components (not shown) as well such as subtractors, fetch logic, comparators, control units, arithmetic logic units (ALUs), and the like. The core 102 may execute various machine instructions 110 of an instruction set 112, which may be stored in memory within, or otherwise accessible to, the core 102. The machine instructions 112 make up an instruction set that includes a variety of operations to be performed. During the course of executing a program, the instruction buffer 104 may receive instruction packets from memory 114 external to the processor 100.

A particular instruction that is fetched and decoded is an instance of a machine code instruction within the machine code set. The instructions 110 that are fetched may be generated by a compiler (not shown).

Decoder 106 includes decode logic 116 that decodes each instruction packet. As noted above, various implementations may include a machine code instruction that includes a counter field, where the counter field specifies a count. The count may specify that when it is non-zero, the processor 100 may pause the servicing of interrupts and/or may cause a shared memory resource to be inaccessible to other processors (not shown). The decoder 106 may fetch such an instruction from the instruction buffer 104, and the decode logic 116 may decode the instruction. The decoding may include the decode logic 116 setting the counter register 109 to a value specified in the instruction. The decoding may also include decode logic 116 causing the interrupt controller 107 to pause the servicing interrupts and/or causing the shared RAM 120 to block access by other processors. The interrupt controller 107 may include hardware or software logic implementing one or more interrupt handler routines.

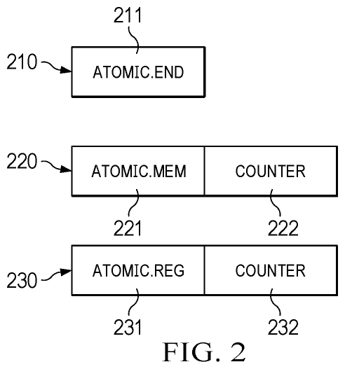

FIG. 2 illustrates example machine instructions 210, 220, 230, according to an embodiment. For instance, example machine code instructions 210, 220, 230 each represent a type of one of the machine code instructions 110 that may be decoded by decoder 106 of the example of FIG. 1.

In this example, machine code instructions 110 are the lowest level of instructions that processor 100 executes. Machine code instructions 110 are typically binary representations of specific operations and data manipulations. In machine code, instructions are typically categorized into different types based on their purpose. One common type is an arithmetic instruction, which performs mathematical operations on data. Machine code instructions 210, 220, 230 represent three different machine code types. Machine code instruction 210 (ATOMIC.END) is a machine code type that forces the value in the counter register 109 to zero. Machine code instruction 220 (ATOMIC.MEM) is a machine code type that causes processor 100 to block access to a shared memory resource (e.g., shared RAM 120) and to set counter register 109 to a value specified by counter field 222. Machine code instruction 230 (ATOMIC.REG) is a machine code type that causes processor 100 to pause the interrupt controller 107 from servicing interrupts and to set counter register 109 to a value specified by counter field 232. In some instances, machine code instruction 220 may combine both blocking access to a shared memory resource and pausing the interrupt controller 107.

The fetching process fetches an instance of a particular machine code instruction type. Looking at instruction 220, the processor 100 may fetch an instance thereof. The binary representation of opcode 221 of this instruction might look like: 10010010, which the processor 100 recognizes as an ATOMIC.MEM operation. An operand is the data on which the instruction operates. In the case of an ATOMIC.MEM instruction, there may be one operand, which in this example is given by the counter field 222. For example, if the machine code is 10010010 00101100, it may represent an ATOMIC.MEM operation to set the value of counter register 109 to 00101100. Of course, an eight-bit operand is only an example, and the scope of implementations may include any appropriately sized counter field. The instruction 230 operates in a similar manner, using opcode 231 and an operand specified by counter field 232. Instruction 210 in this example includes an opcode 211 but does not include an operand portion (e.g., a counter field), as the value of zero is implied.

Machine code instructions 210, 220, 230 are decoded by decode logic 116. The decode logic 116 interprets the binary representation of the instructions, determining its type and reading its operands. Decode logic 116 then sets an appropriate value in counter register 109 and causes the processor 100 to block access to a portion of shared memory and/or pauses interrupt handling at interrupt controller 107.

As noted above, some examples implementations may include using machine code instructions to pause the servicing of interrupts for a specified number of instructions. Machine code instruction 230 may be used for this purpose.

For instance, machine code instruction 230 may be used to pause the servicing of interrupts until the number specified in counter field 232 has been decremented, as subsequent instruction packets are decoded, to zero. In one example, the counter register 109 is located in the set of status registers of processor 100, and its default value may be zero. The machine code instruction 230 may be used to initialize the counter register 109 with a non-zero value that is decremented each time a subsequent packet is processed in the decoding phase. The decoding logic 116 causes the interrupt controller 107 to pause servicing interrupts until the counter register 109 reaches a value of zero. In some examples, the machine code instruction 230 may be treated as a no operation (NOP) if the value in the counter register 109 is non-zero when a machine code instruction 230 is decoded.

Continuing with the example, the program being executed by the processor 100 may have conditional operations, and the quantity of instructions executed at a particular point in the program may vary. In other words, sometimes it may not be known at compile time how many instructions may be executed, but it is usually the case that a worst-case scenario is known at compile time. Therefore, some embodiments may include the compiler setting the counter field 232 to the worst-case scenario, i.e., the largest quantity of instructions to ensure that a particular set of code is not interrupted. Additionally, such embodiments may also use instruction 210 at the end of a set of code to force the count to zero should the set of code end before the count would otherwise reach zero. The following pseudocode may take five, eight, or ten instructions to execute based on whether Val1 or Val2 is true. Regardless of which path is taken, the ATOMIC.END instruction 210 may force the counter to zero, thereby un-pausing interrupt servicing.

```
atomic_reg(10);
if(Cond == Val1)
  VarA = VarB;
else if(Cond == Val2)
  VarA = VarC;
else
  VarA = VarD;
atomic_end( );
```

In some examples, if the value in the counter register 109 is zero when machine code instruction 210 is decoded, then machine instruction 210 may be treated as a NOP.

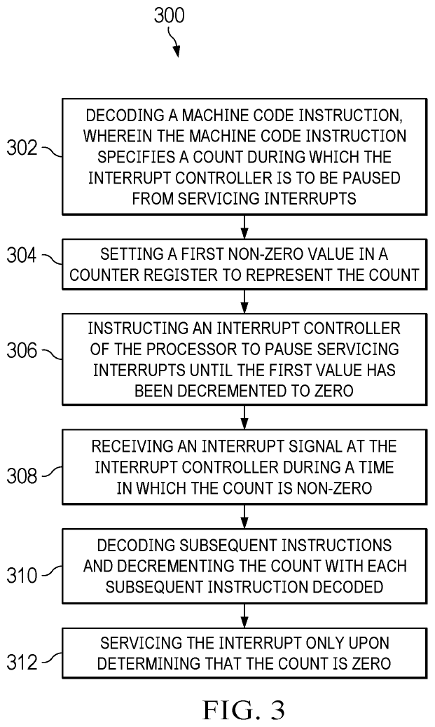

FIG. 3 is an illustration of an example method 300, which may be performed by a processor, such as example processor 100, according to some embodiments.

Although not shown in example method 300, it is understood that there may be a computer program written in a programming language, such as JAVA or PYTHON that may be compiled during compile time. The programming language code may include instructions to make some operations uninterruptible, and the compiler may then generate machine code instructions based on the programming language. For instance, the compiler may determine, for a given operation to be atomic, an appropriate value for the counter register 109 and then generate corresponding machine code instructions (ATOMIC.MEM, ATOMIC.END) therefrom.

Action 302 includes decoding a machine code instruction. In this example, the machine code instruction specifies a count during which the interrupt controller is to be paused from servicing interrupts. An example is illustrated in FIG. 2, as machine code instruction 230, which may include opcode 231 to identify the instruction within a set of machine code instructions and which may include an operand specified by counter field 232, which specifies the count.

Action 304 includes setting a first non-zero value in a counter register to represent the count. In one example, the operand specified by counter field 232 may include an eight-bit binary number as the count, and the count represents a number of instructions to be decoded during which the count will be decremented. Of course, the scope of implementations may include any appropriate length for the count in the counter register. Decoding logic in the processor decodes the machine code instruction and, in response, sets the value from the operand specified by counter field 232 into the counter register 109.

Action 306 includes instructing an interrupt controller of the processor to pause servicing interrupts until the first value has been decremented to zero. For instance, in the example of FIG. 1, the decode logic 116 may instruct the interrupt controller 107 to pause servicing interrupts until the value in counter register 109 is zero.

Action 308 includes receiving an interrupt signal at the interrupt controller during a time in which the count is non-zero. For instance, while the interrupt servicing is paused, the interrupt controller 107 may receive one or more interrupts. However, the interrupt controller 107 may wait to service the interrupt.

Action 310 includes decoding subsequent instructions and decrementing the count with each subsequent instruction decoded. For instance, action 310 may include the processor fetching and decoding further machine code instructions and decrementing the count with each subsequent machine code instruction. For instance, if the count is at 5, then the processor may fetch and decode five subsequent machine code instructions, decrementing the count from 5 to 0, before moving to action 312.

Action 312 includes servicing the interrupt only upon determining that the count is zero. For instance, the interrupt controller 107 may check the counter register 109 at each cycle to ascertain the value stored in the counter register 109. Should the interrupt controller 107 determine that the value stored in the counter register 109 is non-zero, then the interrupt controller 107 continues to pause interrupt servicing. However, should the interrupt controller 107 determine that the value stored in the counter register 109 is zero, then the interrupt controller 107 may then service the interrupt that was received at action 308.

The count may go to zero by being decremented. Alternatively, the count may go to zero by virtue of decoding a second instruction, such as machine code instruction 210 (ATOMIC.END). In any event, interrupt servicing is un-paused once the count reaches zero.

Servicing an interrupt may include executing an interrupt service routine. The interrupt service routine may include checking a flag to determine whether interrupts are enabled. Some interrupts may be maskable (i.e., designed to be enabled or disabled), and if the interrupt service routine determines that interrupts are disabled, then the interrupt service routine may simply discard the interrupt. On the other hand, if interrupts are enabled, then the interrupt service routine may continue normal interrupt processing. Normal interrupt processing may include context saving, reading data from the device, processing input, executing specific software tasks, providing any responses to the interrupt, and restoring context.

Some interrupts may include real-time interrupts, also sometimes referred to as non-maskable interrupts. Real-time interrupts in this example are not susceptible to being disabled. Various embodiments herein include using machine code instructions, such as machine code instructions 210, 220, 230 to manage when real-time interrupts are handled. In other words, without the option of disabling real-time interrupts, various embodiments may use machine code instructions 210, 220, 230 to pause servicing real-time interrupts for a set period of time. An advantage of such embodiments may include reaping the benefits of real-time interrupts (e.g., faster operation for higher priority tasks) while maintaining atomicity of some operations.

The examples above include setting a non-zero value in the counter register and then decrementing the counter. However, the scope of implementations is not so limited. Rather, other embodiments may include initializing the counter register to zero and then incrementing the count as subsequent instructions are decoded. Interrupts continue to be blocked until the counter register reaches a specified limit configured by the ATOMIC.REG instruction. Thus, in a decrementing example, zero serves as a specified limit, whereas in an incrementing example, a non-zero value serves as a specified limit. In any event, the value in counter register is adjusted by being decremented or incremented. Furthermore, in an incrementing example, the counter register may reach the specified limit by virtue of decoding a second instruction, such as machine code instruction 210 (ATOMIC.END).

Various embodiments may include a processor having: a decoder, an interrupt controller communicatively coupled with the decoder, and a counter register communicatively coupled with the decoder, wherein the decoder is configured to perform the actions described above with respect to FIGS. 1-3. Various embodiments may also include a non-transitory computer readable medium storing a computer program comprising sets of computer readable instructions for execution by a computer processor, wherein the computer program is such that, when the sets of computer readable instructions are executed by the processor, the processor is caused to perform the actions described above with respect to FIGS. 1-3.

As noted above, some embodiments may include a processor being able to block other processors from accessing a shared memory resource. For instance, such embodiments may use a machine code instruction, such as machine code instruction 220 (ATOMIC.MEM), to block access by other processors during a set period of time.

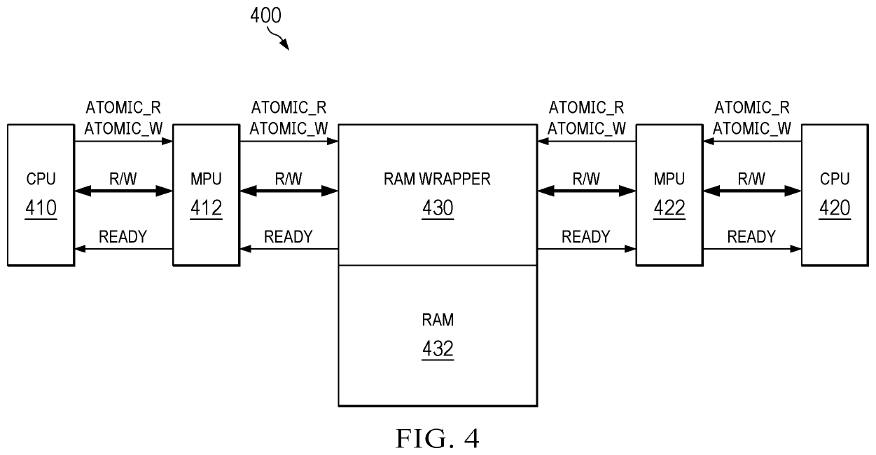

FIG. 4 is an illustration of an example system 400, in which a first processor 410 and a second processor 420 share a memory resource, RAM 432, according to various embodiments. In one example, each of the processors 410, 420 may be the same as or similar to processor 100 of FIG. 1, and the combination of RAM wrapper 430 and RAM 432 may correspond to shared RAM 120 of FIG. 1. RAM wrapper 430 may be instantiated by a memory controller coupled between the RAM 432 and the MPUs 412 and 422 and may decode an access by each processor 410, 420. For example, if processor 410 attempts a read access from the RAM 432, it sends an address to the RAM wrapper 430 indicating the address. The RAM wrapper may grant access or deny access to one or more address ranges at a given time.

Processor 410 communicates with RAM wrapper 430 via memory protection unit (MPU) 412. Similarly, processor 420 communicates with RAM wrapper 430 via MPU 422. MPU 412 includes multiple programmable regions (not shown), referred to as access protection regions. The same is true for MPU 422. Each access protection region is associated with a start address and an end address (i.e., an address range). In one example, there may be 16 or 32 or other appropriate number of address protection regions.

An example of processor 410 communicating with RAM wrapper 430 includes processor 410 transmitting an ATOMIC_R or an ATOMIC_W signal via MPU 412 during a read or write operation. Similarly, processor 420 may transmit an ATOMIC_R or an ATOMIC_W signal to RAM wrapper 430 via MPU 422 during a read or write operation. In the present example, a given processor may perform a read or a write operation with respect to an address range in RAM 432. For instance, when processor 410 attempts a read or a write operation for an address range, it checks the status of the READY signal from RAM wrapper 430. If the READY signal is high, then that means processor 410 may read or write to the address range. On the other hand, if the READY signal is low, the processor 410 may stall its operation until the READY signal goes high. The same is true for processor 420. Furthermore, in this example, each access protection region is protected by a respective READY signal so that even if access is blocked to one access protection region, other access protection regions may be associated with a READY signal that is high. It should be noted that the present example assumes that the various signals are active-high signals; other implementations may use similar signals that are active-low.

Continuing with the example, the processor 410 may cause the RAM wrapper 430 to de-assert the READY signal to MPU 422 by transmitting either an ATOMIC_R or an ATOMIC_W signal to RAM wrapper 430. Similarly, the processor 420 may cause the RAM wrapper 430 to de-assert the READY signal to MPU 412 by transmitting either an ATOMIC_R or an ATOMIC_W signal to RAM wrapper 430. Each processor 410, 420 may honor its READY signal by performing a read or write if the READY signal is high and stalling a read or write if the READY signal is low. If the processor 410 and the processor 420 both assert an atomic signal at the same time for a particular address range, then RAM wrapper 430 may provide for arbitration.

Various embodiments may cause the processor 410 or the processor 420 to transmit an atomic signal (ATOMIC_R or ATOMIC_W) by decoding machine code instruction 220 (ATOMIC.MEM). When processor 410 or 420 decodes machine code instruction 220, it sets a value in counter register 109 corresponding to a value in counter field 222. The processor 410 or 420 then decodes further machine code instructions, decrementing the count in counter register 109 and maintaining the assertion of its atomic signal until the count reaches zero. Furthermore, the machine code instruction 220 (ATOMIC.MEM) may also pause servicing interrupts, as described above with respect to machine code instruction 230 (ATOMIC.REG).

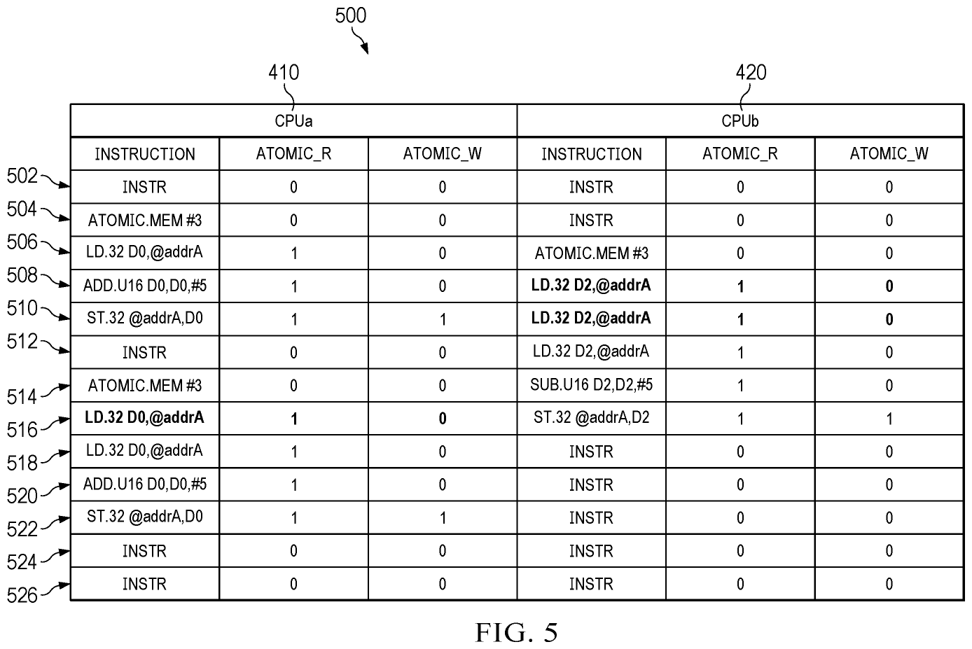

An example use of machine code instruction 220 is described with respect to FIG. 5. FIG. 5 illustrates an example method 500 for blocking access to a shared memory resource, according to various embodiments.

At operation cycle 502, both processor 410 and processor 420 are operating simultaneously without conflict. However, beginning with operation cycle 504, processor 410 decodes an ATOMIC.MEM instruction, thereby asserting ATOMIC_R and causing RAM wrapper 430 to de-assert the READY signal to MPU 422. Processor 410 performs three operations-load, add, and store at operation cycles 506-510. Two operation cycles later at action 508, processor 420 attempts an access, and the load operation of processor 420 gets stalled because of the atomic signal of processor 410 being high. In this example, processor 420 must wait until the atomic signal of processor 410 is lowered before it may complete its load operation. Processor 410 asserts its atomic signal through operation cycle 510 and de-asserts its atomic signal at operation cycle 512. Furthermore, processor 420 then un-stalls its load, subtract, and store operations beginning at operation cycle 514 and continuing through operation 516.

Note that at operation cycle 506, processor 420 decodes its own ATOMIC.MEM instruction and attempts to assert its atomic signal, but that is made moot by the atomic signal being asserted by CPU 410 first. However, processor 420 maintains its assertion of its atomic signal through operation cycle 516 so that its load, subtract, and store operations maintain their atomicity.

Processor 410 attempts another operation at operation cycle 514, and it gets stalled by processor 420 until operation cycle 518, when the atomic signals of processor 420 are de-asserted. Processor 410 then un-stalls at operation cycle 518 to perform its load, add, and store operations atomically through operation cycle 522. At operation cycles 524-526, both processors 410, 420 perform instructions without conflict.

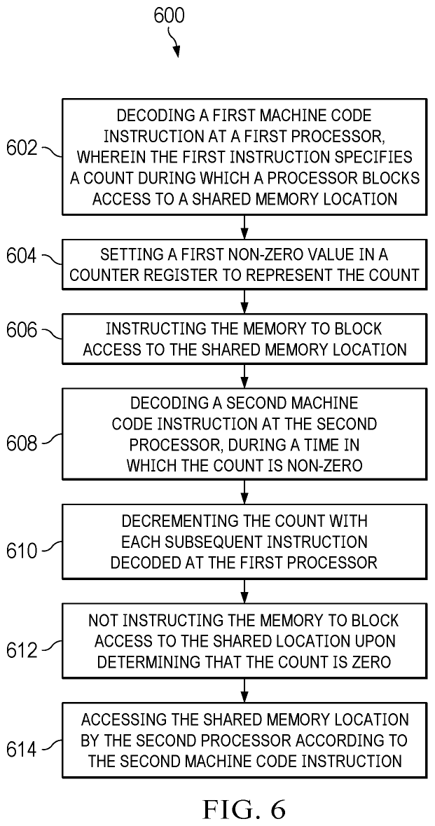

FIG. 6 is an illustration of an example method 600, which may be performed by processors 410, 420, according to various embodiments.

Action 602 includes decoding a first machine code instruction at a first processor. For instance, the machine code instruction may include machine code instruction 220 (ATOMIC.MEM), which specifies a count during which the first processor blocks access to a shared memory location. Examples of a shared memory location may include a range of addresses at shared RAM 120 and a range of addresses at RAM 432. However, the scope of implementations may include blocking access to the entirety of a particular shared memory, rather than only a range of addresses.

Action 604 includes setting a first non-zero value in a counter register to represent the count. For instance, action 604 may include setting a value for the count in counter register 109. The non-zero value may be specified by an operand, such as counter field 222.

Action 606 includes instructing the memory to block access to the shared memory location. In the example of FIG. 4, a first processor (e.g., processor 410) may assert one of its atomic signals (ATOMIC_R or ATOMIC_W) to cause RAM wrapper 430 to de-assert the READY signal to the second processor (e.g., 420).

Action 608 includes decoding a second machine code instruction at the second processor. At action 608, the count is non-zero, so the second processor is blocked from reading or writing to the shared memory resource. An example is found in FIG. 5, in which processor 420 is caused to stall at operation cycle 506 because the processor 410 has raised an atomic signal.

Action 610 includes decrementing the count with each subsequent instruction decode of the first processor. For instance, the first processor may continue to decode instructions while the count is non-zero. An example is shown at FIG. 5, in which processor 420 performs load, add, and store operations at operation cycles 506-510 while one of the atomic signals is raised. Action 610 may include the processor decrementing the count at a counter register, such as counter register 109.

Action 612 includes not instructing the memory to block access to the shared location upon determining that the count is zero. For instance, the count may go to zero through decrementing. Additionally, or alternatively, the count may go to zero through being forced to zero by virtue of the first processor decoding another machine code instruction (e.g., machine code instruction 210, ATOMIC.END). Action 612 may include the first processor de-asserting an atomic signal, which causes the RAM wrapper 430 to assert the READY signal to processor 420.

Action 614 includes accessing the shared memory location by the second processor according to the second machine code instruction. An example is shown at FIG. 5, in which processor 420 un-stalls and performs load, subtract, and store operations at operation cycles 512-516. During this time, the second processor raises one or both of its atomic signals to cause the first processor to be blocked from accessing the shared memory resource.

The scope of implementations is not so limited to decrementing the counter register. Rather, other embodiments may include initializing the counter register to zero and then incrementing the count as subsequent instructions are decoded. Access to the shared memory location continues to be blocked until the counter register reaches a specified limit configured by the ATOMIC.MEM instruction. Thus, in a decrementing example, zero serves as a specified limit, whereas in an incrementing example, a non-zero value serves as a specified limit. In any event, the value in counter register is adjusted by being decremented or incremented. Furthermore, in an incrementing example, the count may reach the specified limit by virtue of decoding a second instruction, such as machine code instruction 210 (ATOMIC.END).

Various embodiments may include a processor having: a decoder, an interrupt controller communicatively coupled with the decoder, and a counter register communicatively coupled with the decoder, wherein the decoder is configured to perform the actions described above with respect to FIGS. 4-6. Various embodiments may also include a non-transitory computer readable medium storing a computer program comprising sets of computer readable instructions for execution by a computer processor, wherein the computer program is such that, when the sets of computer readable instructions are executed by the processor, the processor is caused to perform the actions described above with respect to FIGS. 4-6.

The term “semiconductor die” is used herein. The semiconductor die may include an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to form a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A processor comprising:
a decoder, an interrupt controller communicatively coupled with the decoder, and a counter register communicatively coupled with the decoder, wherein the decoder is configured to:
receive a first instruction that includes a counter field, wherein the counter field specifies a count during which the interrupt controller is to be paused from servicing interrupts;
decode the first instruction, including:
setting a first value in the counter register;
instructing the interrupt controller to pause servicing interrupts until the first value has been adjusted to a specified limit; and
adjusting the count with each subsequently decoded instruction.

2. The processor of claim 1, wherein the decoder is configured to:
set the first value to be a non-zero quantity according to the count, wherein the specified limit is zero; and
decrement the count with each subsequently decoded instruction.

3. The processor of claim 2, wherein the decoder is further configured to:
receive a second instruction, at a time in which the count has been decremented but is non-zero, wherein the second instruction specifies to set the count to zero; and
decode the second instruction, including:
setting the count to zero.

4. The processor of claim 2, wherein the decoder is further configured to:
receive a second instruction, at or after a time in which the count has been decremented to zero, wherein the second instruction specifies to set the count to zero; and
decode the second instruction, including:
treating the second instruction as a no operation.

5. The processor of claim 2, wherein the interrupt controller is configured to:
receive a first interrupt signal;
determine that the count is non-zero; and
in response to determining that the count is non-zero, execute no interrupt service routine.

6. The processor of claim 5, wherein the interrupt controller is further configured to:
subsequent to determining that the count is non-zero, determine that the count is zero; and
execute the interrupt service routine according to the first interrupt signal.

7. The processor of claim 5, wherein the interrupt controller is further configured to:
subsequent to determining that the count is non-zero, determine that the count is zero;
check an interrupt enable flag in response to the first interrupt signal representing a maskable interrupt; and
execute the interrupt service routine in response to determining that the interrupt enable flag indicates that interrupts are enabled.

8. The processor of claim 5, wherein the interrupt controller is further configured to:
subsequent to determining that the count is non-zero, determine that the count is zero;
execute the interrupt service routine, regardless of a state of an interrupt enable flag, in response to the first interrupt signal representing a real-time interrupt.

9. The processor of claim 1, wherein the first instruction is an instance of a machine code instruction within a machine instruction set, and wherein the counter register comprises a status register.

10. A method comprising:
fetching a first instruction, wherein the first instruction is an instance of a machine code instruction within a machine instruction set of a processor;
decoding the first instruction, wherein the first instruction specifies a count during which an interrupt controller is to be paused from servicing interrupts;
setting a first value in a counter register;
instructing an interrupt controller of the processor to pause servicing interrupts until the first value has been adjusted to a specified limit;
receiving an interrupt signal at the interrupt controller during a time in which the first value has not been adjusted to the specified limit; and
servicing an interrupt, corresponding to the interrupt signal, only upon determining that the first value has been adjusted to the specified limit.

11. The method of claim 10, further comprising:
decoding subsequent instructions and adjusting the first value with each subsequent instruction decoded.

12. The method of claim 10, wherein the first value is zero and the specified limit is non-zero and corresponds to the count, and wherein adjusting the counter register includes incrementing the counter register, the method further comprising:
decoding a second instruction, wherein the second instruction specifies that the count be set to zero; and
setting the counter register to the specified limit in response to the second instruction.

13. The method of claim 10, wherein servicing the interrupt only upon determining that the first value has been adjusted to at the specified limit comprises:
delaying servicing the interrupt;
while delaying servicing the interrupt, monitoring the counter register; and
servicing the interrupt in response to determining that the counter register stores is the specified limit.

14. The method of claim 10, wherein the interrupt comprises a real-time interrupt.

15. The method of claim 10, wherein the interrupt comprises a maskable interrupt, the method further comprising:
determining that interrupts are enabled; and
servicing the interrupt at least in part in response to determining that interrupts are enabled.

16. A non-transitory computer readable medium storing a computer program comprising sets of computer readable instructions for execution by a computer processor, wherein the computer program is such that, when the sets of computer readable instructions are executed by the processor, the processor is caused to:
set a first value in a counter register, wherein the first value represents a count during which an interrupt controller is to be paused from servicing interrupts;
cause an interrupt controller of the processor to pause servicing interrupts until the first value has been adjusted to a limit;
receive an interrupt signal at the interrupt controller during a time in which the first value has not been adjusted to the limit; and
service an interrupt, corresponding to the interrupt signal, after a pause and based at least in part upon determining that the counter register stores the limit.

17. The non-transitory computer readable medium of claim 16, wherein the computer readable instructions to cause the processor to service the interrupt includes computer readable instructions to cause the processor to:
check a value of an interrupt enable flag; and
continue servicing the interrupt based at least in part on determining that the interrupt enable flag indicates that interrupts are enabled.

18. The non-transitory computer readable medium of claim 16, wherein the computer readable instructions to cause the processor to service the interrupt includes computer readable instructions to cause the processor to:
service a real-time interrupt.

19. The non-transitory computer readable medium of claim 16, wherein the first value is non-zero and the limit is zero, further comprising computer readable instructions to cause the processor to:
decode an instruction that specifies that the count be set to zero; and
set the count to zero in response to the instruction.

20. The non-transitory computer readable medium of claim 16, wherein the first value is zero and the limit is non-zero, further comprising computer readable instructions to cause the processor to:
decode subsequent instructions and increment the first value with each subsequent instruction decoded.
